(19) United States
(12) Patent Application Publication
(10) Pub. No.: US 2008/0176559 A1
(43) Pub. Date: Jul. 24, 2008

(54) Seamless roaming for a service within IP datacasting over a digital broadband broadcast network

(75) Inventors: Jani Vare, Kaarina (FI); Kari S. Virtanen, Merimasku (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/625,928

(22) Filed: Jan. 23, 2007

(51) Int. Cl. H04Q 7/20

(52) U.S. Cl. 455/432.1

(57) ABSTRACT

Methods, apparatuses, and computer media are provided for supporting roaming between platforms which allow for continuous delivery of the same content. A mobile terminal receives digital content from a current signal for a selected service from a current platform. The mobile terminal obtains platform information about another platform that provides the selected service in a candidate cell. When the mobile terminal determines that the signal quality is below a predetermined threshold, the mobile terminal selects another signal in a candidate cell. When the current platform is not available in the candidate cell, the mobile terminal performs a roaming procedure by changing platforms. When the current platform is supported in the candidate cell, the mobile terminal performs a handover to the candidate cell. The mobile terminal may evaluate the availability of roaming services and select another signal based on the availability of roaming services.

### FIELD OF THE INVENTION

The invention relates to roaming in a digital broadband broadcast network. More particularly, the invention supports roaming between platforms which allow for continuous delivery of the same content.

### BACKGROUND OF THE INVENTION

Digital broadband broadcast networks (e.g., Digital Video Broadcast-Handheld) enable end users to receive digital content as they move from location to location. Digital content may include video, audio, data, and so forth. Using a mobile terminal, a user may receive digital content over a wireless digital broadcast network. The digital broadcast signal may include service information which may provide the mobile terminal with information about available digital content, as well as information about the network and other nearby networks. The mobile terminal may then display a list or menu of available digital content. A user may then select a program or programs to watch, listen to, or otherwise consume.

As a user travels between networks, a mobile terminal may need to find another service platform when the mobile terminal moves into another cell (in which the current broadcast signal drops below a desired threshold) and the current service platform cannot support a candidate cell. The user of the mobile terminal may wish to continue viewing or listening to the same content without having to find a new platform that offers the same service. With current technology, the mobile terminal typically needs to cancel the service (e.g., stop the video stream), set a new platform that services the candidate cell, update the electronic service guide (ESG) in the new platform, and manually find the same service in the new platform. With such a scenario, the service is disrupted from the user's perspective.

Therefore, there is a need in the art to provide continuous service for a mobile terminal as the terminal moves through a digital broadband broadcast network.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

An aspect of the present invention provides methods, apparatuses, and computer media for supporting roaming between platforms which allow for continuous delivery of the same content.

With another aspect of the invention, a mobile terminal receives digital content from a current signal for a selected service from a current platform. The mobile terminal obtains platform information about another platform that provides the selected service in a candidate cell. When the mobile terminal determines that the signal quality is below a predetermined threshold, the mobile terminal selects another signal in a candidate cell. When the current platform is not available in the candidate cell, the mobile terminal performs a roaming procedure by changing platforms. When the current platform is supported in the candidate cell, the mobile terminal performs a handover to the candidate cell.

With another aspect of the invention, a mobile terminal supports digital video broadcasting for handhelds (DVB-H). Platform information is received in at least one IP/MAC Notification Table (INT). The mobile terminal acquires roaming information from a Network Information Table (NIT) that includes at least one roaming descriptor.

With another aspect of the invention, a mobile terminal evaluates the availability of roaming services within the current cell and the candidate cell. The mobile terminal discovers the roaming services available within the current cell and the candidate cell and selects another signal based on the availability of roaming services.

### BRIEF DESCRIPTION OF THE DRAWINGS

The present invention is illustrated, by way of example and not limitation, in the accompanying figures in which like reference numerals indicate the same or similar elements and in which:

FIG. 1 shows a functional depiction of a digital broadband broadcast system in accordance with an embodiment of the invention;

FIG. 2 shows advertising of roaming services available in neighboring cells in a digital video broadcasting system in accordance with an embodiment of the invention;

FIG. 3 shows a flow diagram for service startup, handover, and roaming in a digital video broadcasting system in accordance with an embodiment of the invention;

FIG. 4 shows a flow diagram for service startup, handover, and roaming in a digital video broadcasting system in accordance with an embodiment of the invention;

FIG. 5 shows a scenario for service configuration in a digital video broadcasting system in accordance with an embodiment of the invention;

FIG. 6A shows a roaming descriptor used in a digital broadcasting system in accordance with an embodiment of the invention;

FIG. 6B shows a roaming descriptor used in a digital broadcasting system in accordance with an embodiment of the invention; and

FIG. 7 illustrates a functional block diagram of a mobile terminal in accordance with an embodiment of the invention.

### DETAILED DESCRIPTION OF THE DRAWINGS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

In the following discussion, the following term is used:
Platform—a set of data streams managed by an organization. A service platform may span several transport streams within one or more digital broadband broadcast networks. With an embodiment of the invention, a service platform represents a harmonized IP/MAC address space, i.e., an address space without address conflicts for supporting services over digital video broadcasting (DVB) facilities. A platform may be identified by a platform identification (Platform_id).

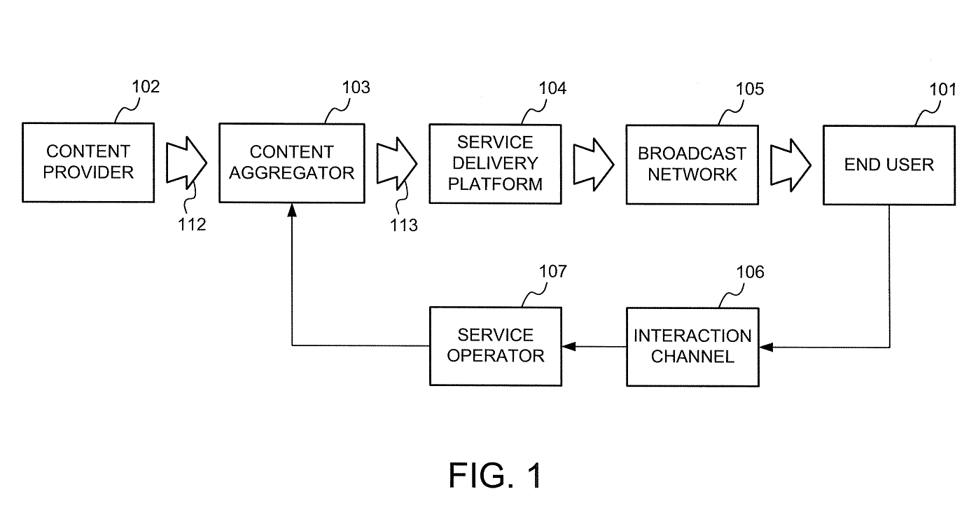

FIG. 1 shows a functional depiction of a digital broadband broadcast system in accordance with an embodiment of the invention.

FIG. 1 illustrates a suitable digital broadband broadcast system in which one or more illustrative embodiments of the invention may be implemented. The blocks represent functional portions of the digital broadband broadcast system and need not be carried out separately. For example, the functions of content provider 102 and content aggregator 103 may be provided by a single entity or within the same subsystem. Systems such as the one illustrated here may be utilized by a digital broadband broadcast technology, for example Digital Video Broadcast-Handheld (DVB-H). Examples of other digital broadcast standards and systems which may utilize the invention include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Digital Audio Broadcasting (DAB), Digital Radio Mondiale (DRM), Forward Link Only (FLO), and MediaFLO. Other digital broadcasting standards and techniques, now known or later developed, may also be used.

The system illustrated in FIG. 1 may be utilized to provide Internet Protocol (IP) Datacasting to end user 101. In an IP Datacasting (IPDC) system, digital content is delivered to an end user in the form of network packets. The system may also be utilized to provide other forms of digital broadcasting, such as may be used by those technology standards listed above. IPDC network packets may comprise IPv4 or IPv6 packets.

Digital content 112 may be created and/or provided by content provider 102 and may include video signals, audio signals, data, and so forth. For example, content provider 102 may be providing a video signal of an international sporting event. Content 112 may also include an accompanying audio signal. Content 112 may further include data such as updated scores of the event. Content provider 102 may then deliver content 112 to content aggregator 103, who may provide content 112 in the form of a service 113 to service delivery platform 104 for eventual delivery to end user 101. Service delivery platform 104 may comprise software installed on a server, wherein the server comprises a processor and associated memory. Other implementations of service delivery platform 104 may be available.

Service delivery platform 104 may utilize IP datacasting for delivering services 113 to end user 101. Service delivery platform 104 may form service 113 into network packets such as IPv6 packets. Using DVB-H as an example, service 113 may be formed into IP network packets such as IPv6 packets. The network packets are then bundled into transport streams (e.g., MPEG-TS streams), along with metadata about offered services and their delivery. Metadata incorporated with content in a DVB system may comprise a series of standardized data tables including, for example, a Network Information Table (NIT) and one or more IP/MAC Notification Tables (INT). Exemplary standards for metadata (also known as service information) used in digital video broadcasting and data broadcasting are found, among other places, in two European Telecommunications Standards Institute documents: “Digital Video Broadcasting (DVB): Specification for Service Information (SI) in DVB Systems,” ETSI EN 300 468 (latest version 1.6.1), and “Digital Video Broadcasting (DVB): DVB Specification for Data Broadcasting,” ETSI EN 301 192 (latest version 1.4.1).

Broadcast network 105 distributes the transport streams provided by system delivery platform 104 to end user 101, where the network packets can be unbundled and utilized. End user 101 may utilize some form of interaction channel 106 in order to communicate with service operator 107. This interaction channel may include a cellular network, or some other system for relaying messages from end user 101 to service operator 107. Messages may be sent via a two-way audio connection (e.g., phone call), via short message service (SMS), via multimedia message service (MMS), via a web browser, or via some other communication scheme. By communicating with service operator 107, end user 101 may be enabled to view restricted or for-pay content. Service operator 107 may enable this authorization by communicating with content aggregator 103.

IP addresses utilized by a particular service delivery platform 104 need only be unique for that service delivery platform. This means that the same IP address may be used by separate service delivery platforms without causing a conflict. As such, service delivery platform 104 may be viewed as a private IP network, where any possible IP address may be assigned to network packets.

Services provided by service delivery platform 104 may be provided by content aggregator 103 or directly by content provider 102. Services may additionally be provided to service delivery platform 104 by other content aggregators and other content providers. All of the services available to end user 101 from service delivery platform 104 may be announced by their IP addresses delivered via IP/MAC Notification Tables (INT's), or via other forms of metadata.

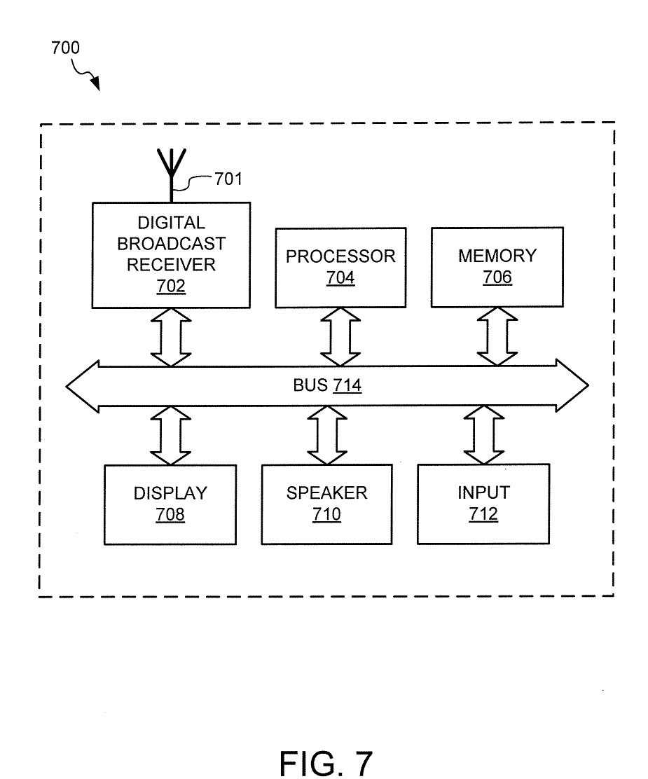

Among the candidate networks for handover (networks which may be overlapping) are Networks 1, 2, and 3. Each network broadcasts one or more IP/MAC Notification Tables (INT's), which are received and interpreted by mobile terminal 700 as shown in FIG. 7. Each network may be broadcasting services from different service delivery platforms, identified by the differing platform_ids displayed in the INT tables of each network. Within each INT table, the IP addresses of services available on that network are announced. INT tables are typically broadcast at regular intervals by each of the broadcast networks.

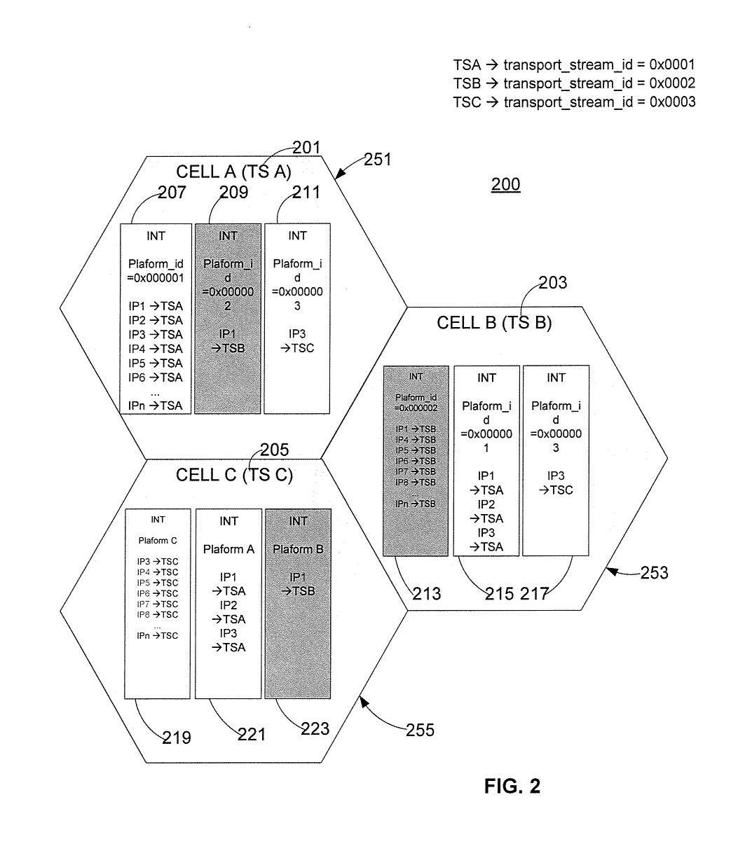

FIG. 2 shows advertising of roaming services available in neighboring cells in a digital video broadcasting system 200 in accordance with an embodiment of the invention.

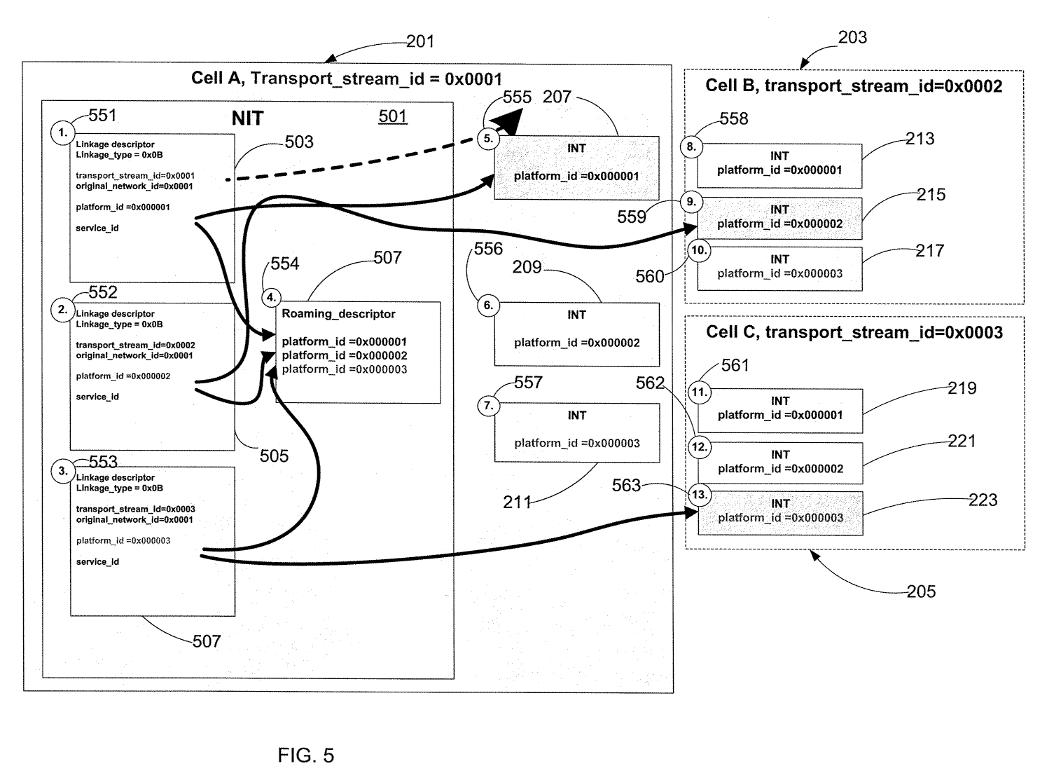

FIG. 2 presents a network configuration that includes three platforms A, B, and C. (FIG. 2 does not explicitly show a platform. Each platform is supported by a configuration that is specified by the Network Information Table (NIT) (e.g., NIT 501 as shown in FIG. 5) and IP/MAC Notification Tables (e.g., INT's 207-223). Platforms A, B, and C have platform_ids equal to 0x000001, 0x000002, and 0x000003, respectively.

With the exemplary embodiment shown in FIG. 2, cell 251 is served by platform A, cell 253 is served by platform B, and cell 255 is served by platform C. Each cell broadcasts a transport stream. However, embodiments of the invention support configurations in which a plurality of platforms serve a given cell, e.g., both platforms A and B may serve cell 203. With the exemplary embodiment shown in FIG. 2, each cell broadcasts a transport stream, where cells 251, 253, and 255 broadcast transport streams 201, 203, and 205, respectively. However, embodiments of the invention support configurations in which a plurality of transport streams are broadcast by a cell.

Each transport stream is conveyed by a broadcast signal. A mobile terminal can determine a signal quality (e.g., signal strength, frame error rate, or bit error rate) of the signal. As mobile terminal 700 moves within a service region, the signal quality of the received signal varies. When the signal quality falls below a predetermined threshold, the quality of service may be degraded as perceived by the user. For example, as mobile terminal moves from cell 251 to cell 253, the received signal strength associated with TS A 201 may drop below a predetermined signal level. Consequently, mobile terminal 700 may switch to another signal that has a signal level above the predetermined signal level and that carries TS B 203.

With an embodiment of the invention, mobile terminal 700 switches to another signal by performing a handover from one cell to another cell if the current platform also serves the neighboring cell that mobile terminal 700 is entering. If that is not the case, mobile terminal 700 roams into the neighboring cell by changing platforms.

Platforms A, B, and C have defined roaming addresses (IP1, IP2 and IP3) in which different services are mapped to different IP addresses. If one of the IP addresses exist in any of given platforms (A, B or C), the service is same. IP addresses may be uniquely defined for all platforms (A, B, C), where addresses IP4, . . . , IPn are unique only within the platforms they are declared.

With the exemplary service configuration shown in FIG. 2 for system 200, IP4-IP6 addresses (which are associated with corresponding services) are unique within platform A. IP4-IP8 addresses are unique only within platform B. IP4-IP8 are unique only within platform C. In other words, in this example, roaming is not supported when mobile terminal 700 is tuned to a unique IP address.

Referring to transport stream (TS A) 201 that is broadcast in cell 251, INT 207 announces all services of platform A (platform_id=0x000001) that are available in TS A 201, which is broadcast in cell 251 (cell A). INT 209 announces roaming services of platform B (platform_id=0x000002) that are available in TS B 203, which is broadcast in cell 253 (cell B). In this example, platform B supports roaming for IP1 in cell 253. INT 211 announces roaming services of platform C (platform_id=000003) that are available in TS C 205, which is broadcast in cell 255 (cell C). Platform C supports roaming for IP3 in cell 255.

Transport stream (TS B) 203 (broadcast in cell 253) carries INT 213, 215, and 217, which have similar functionality as INT 207, 209, and 211. Similarly, transport stream (TS C) 205 carries INT 219, 221, and 223.

While the service configuration shown in Figure does not support multiple platforms in a cell, embodiments of the invention support multiple platforms in a cell. For example, platform A may be supported in both TS A 201 and TS B 203. (With an embodiment of the invention, INT 207 provides information (IP address list+parameters) for platform A. The NIT contains a list of transport streams where platform A exists.) This being the case, if mobile terminal 700 is currently served by platform A and moves into cell 253, mobile terminal 700 will continue to be served by platform A by performing a handover.

The following scenarios provide examples of a digital video broadcasting system with a configuration shown in FIG. 2.
Example 1:
1. Mobile terminal 700 has tuned to TS A 201, set platform A (roaming support for A, B and C) and created filter IP1
2. Mobile terminal 700 receives INT 207, 209, and 211 for each platform (A, B and C) and updates handover/roaming candidates
   platform A/TS A 201 (current)
   platform B/TS B 203 (roaming needed)
3. Signal corresponding to TS A 201 (current) falls below handover threshold and TS B 203 has good signal (e.g., sufficiently above the handover threshold)
   Handover is not possible, since platform A is not support by TS B 203
   Roaming to platform B is possible
4. Mobile terminal 700 roams to TS B 203
Example 2:
1. Mobile terminal 700 has tuned to TS A 201, set platform A (roaming support for A, B and C) and created filter IP3
2. Mobile terminal 700 receives INT 207, 209, and 211 for each platform (A, B and C) and updates handover/roaming candidates
   a. platform A/TS A 201 (current)
   b. platform C/TS C 205 (roaming needed)
3. Signal in TS A 201 (current) falls below handover threshold and TS C 205 has good signal
   a. Handover is not possible, since platform A is not supported by TS C 205
   b. Roaming to platform C is possible
4. Mobile terminal 700 roams to TS C 205

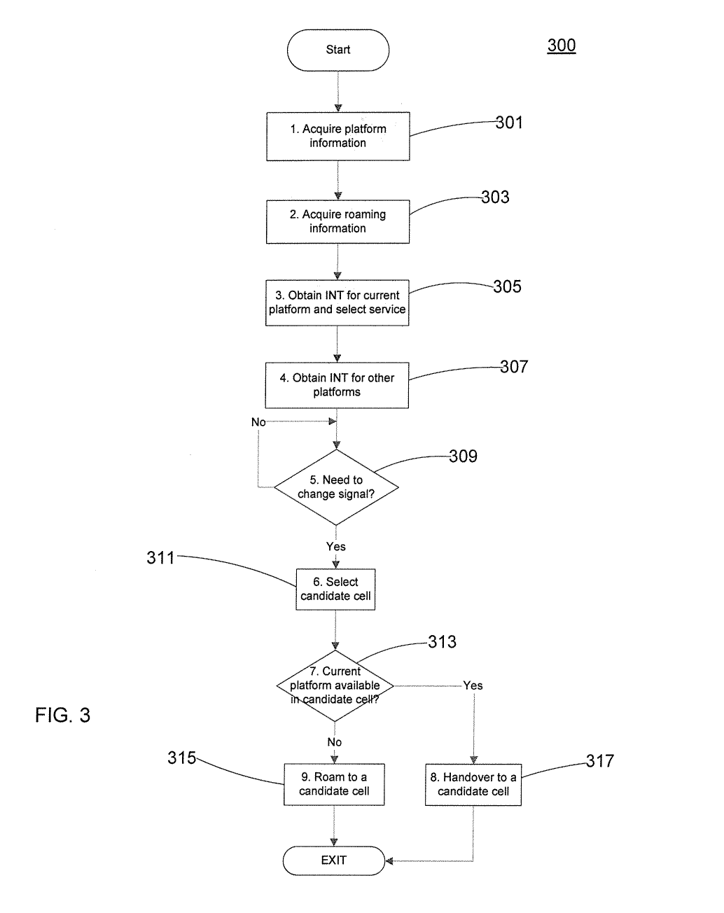

FIG. 3 shows flow diagram 300 for service startup, handover, and roaming in a digital video broadcasting system in accordance with an embodiment of the invention. In step 301, mobile terminal 700 acquires information of all platforms including the platform identification and platform name. In step 303, mobile terminal 700 acquires roaming information. This information may include a list of platforms that have roaming agreements with each other and the IP address range that is unique within the roaming agreement. As will be discussed, roaming descriptor 507, as shown in FIG. 5, provides platform roaming relationships.

In step 305, mobile terminal 700 obtains the INT for the current platform and the selected service. For example, if mobile terminal 700 is in cell 251, mobile terminal 700 would obtain INT 207. A handover/roaming candidate cell list is created when the service is selected. In step 307, the INT's for other platforms that have roaming agreements with the current platform are obtained. Mobile terminal 700 checks all IP addresses in the current platform and compares the IP addresses against a roaming IP address range. If an IP address of an active service is found in the current platform and inside the roaming IP address range, the corresponding cell is added to the handover/roaming cell list.

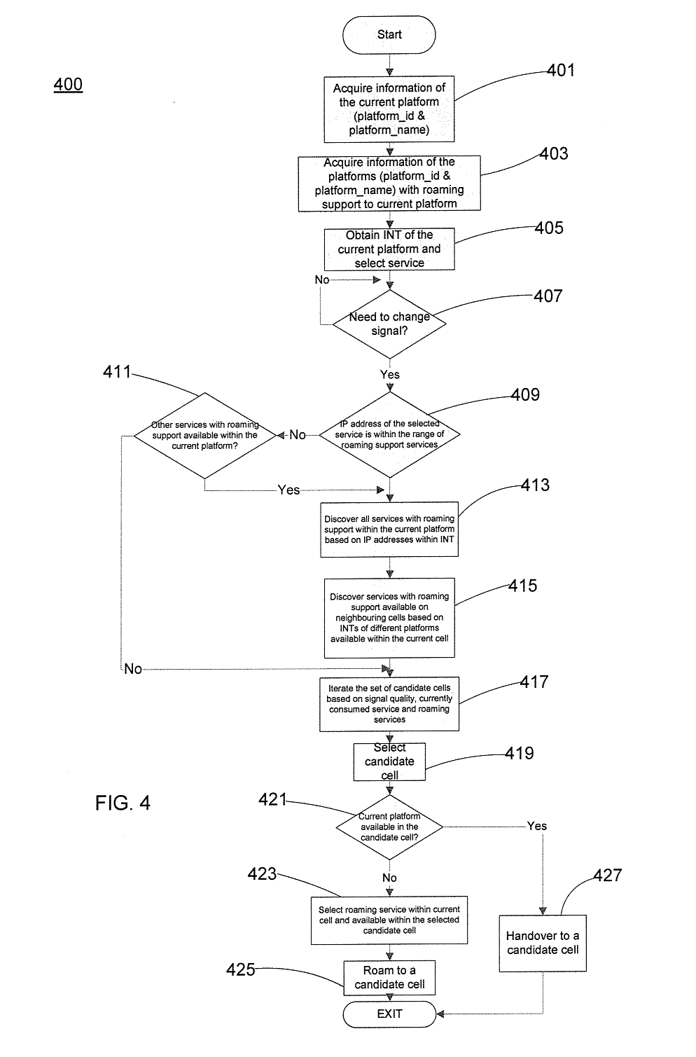

In step 309, mobile terminal 700 performs a handover/roaming algorithm to determine if the mobile terminal 700 should switch to another signal. For example, the signal strength of the received signal is measured to determine if the signal strength is below a predetermined threshold. In step 311, a candidate cell list is ordered by signal quality, where the selected candidate cell has the best signal quality. A candidate cell is typically a neighboring cell of the current cell. Embodiments of the invention support other parameters when ordering the candidate list. For example, a number of available roaming services may be considered. This will be further discussed with FIG. 4.

In step 317, if the current platform is available in the selected candidate cell (as determined by step 313), a handover is performed. Otherwise, mobile terminal 700 performs a roaming procedure corresponding to step 315. When performing a handover, mobile terminal 700 verifies the signal quality after the handover and updates Program Specific Information (PSI), Service Information (SI), and Packet Identifiers (PID's) for active services. When performing roaming, mobile terminal 700 verifies the signal quality after roaming, changes platforms, and updates Program Specific Information (PSI), Service Information (SI), and Packet Identifiers (PID's) for active services.

FIG. 4 shows flow diagram 400 for service startup, handover, and roaming in a digital video broadcasting system in accordance with an embodiment of the invention. Steps 401, 403, 405, 407, 419, 421, 425, and 427 are similar to steps 301, 303, 305, 309, 311, 313, 315, and 317 as previously discussed.

Step 409 determines if the IP address of the selected service is within the range of supported roaming services. If not, step 411 determines whether other services with roaming support are available with the current platform. If so, then steps 413 and 415 are executed. With step 413, mobile terminal 700 discovers all services within the current platform that have roaming support. In step 415, mobile terminal 700 discovers services with roaming support that are available on neighboring cells. Mobile terminal 700 obtains this information by accessing the INT's of the different platforms. The INT's are available within the current cell (e.g., INT's 209 and 211 as shown in FIG. 2).

In step 417, the list of candidate cells is determined from the neighboring cells based on the signal quality and the number of available services with roaming support. Mobile terminal 700 selects a candidate cell based on a metric that combines the signal quality and the availability of available services.

If step 421 determines that the current platform is not available on the selected candidate cell, step 423 selects a service within the current cell that is available in the candidate cell. Typically, mobile terminal 700 attempts to maintain the service that was previously selected.

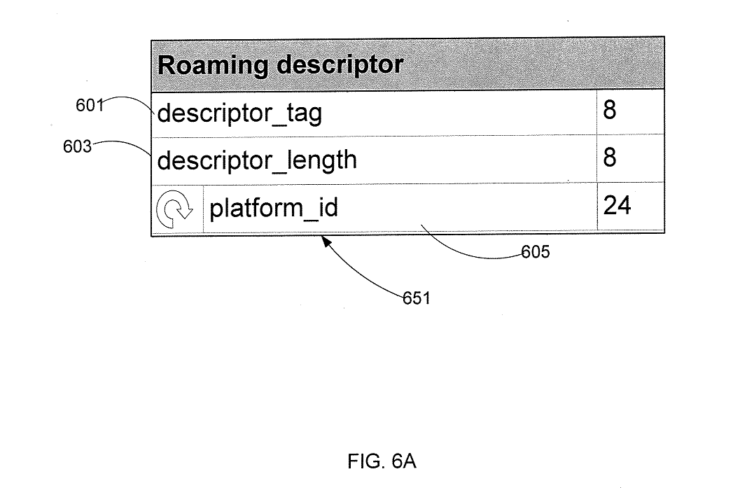

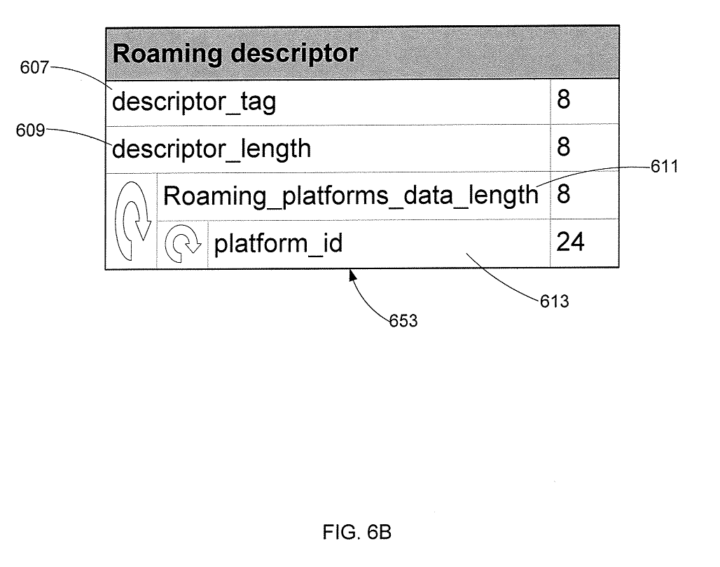

FIG. 5 shows a scenario for service configuration in a digital video broadcasting system in accordance with an embodiment of the invention. The following steps sequence through the scenario. Referring to FIG. 2:
Step 551: Linkage descriptor 503 indicates the platforms available in transport stream 201 with transport_stream_id=0x0001. The only platform available within transport stream 201 (identified by transport_stream_id=0x0001 & original_network_id=0x0001 pair) is the platform with platform_id=0x000001. (With an embodiment of the invention, a transport stream is uniquely identified by transport_stream_id and the original_network_id.)
Step 552: Linkage descriptor 505 indicates the platforms available in transport stream 203 with transport_stream_id=0x0002. The only platform available within transport stream 203 (identified by transport_stream_id=0x0002 & original_network_id=0x0001 pair) is the platform with platform_id=0x000002.
Step 553: Linkage descriptor 507 indicates the platforms available in transport stream 205 with transport_stream_id=0x0003. The only platform available within transport stream 205 (identified with transport_stream_id=0x0003 & original_network_id=0x0001 pair) is platform of platform_id=0x000003.
Step 554: Roaming descriptor 507 maps such platforms together, which support mutual roaming. Roaming descriptor 507 may be implemented as roaming descriptor 651 or 653 as shown in FIGS. 6A and 6B, respectively.
Step 555: INT 207 of platform with platform_id=0x000001 announces the services available within transport_stream 201 (the transport stream carried in signal that receiver is currently tuned into).
Step 556: INT 209 of platform with platform_id=0x000002 announces ‘roaming services’ available in TS B 203. This INT does not include any services available within ‘current TS’, i.e., TS A 201.
Step 557: INT 211 of platform with platform_id=0x0003 announces ‘roaming services’ available in TS C 205. This INT does not include any services available within ‘current TS’, i.e., TS A 201.
Step 558: INT 213 of platform with platform_id=0x000001 announces ‘roaming services’ available in TS A 201.
Step 559: INT 215 of platform with platform_id=0x000002 announces services available in TS B 203.
Step 560: INT 217 of platform with platform_id=0x000003 announces ‘roaming services’ available in TS C 205.
Step 561: INT 219 of platform with platform_id=0x000001 announces ‘roaming services’ available in TS A 201.
Step 562: INT 221 of platform with platform_id=0x000002 announces ‘roaming services’ available in TS B 203.
Step 563: INT 223 of platform with platform_id=0x000003 announces services available in TS C 205.

FIG. 6A shows roaming descriptor 651 used in a digital broadcasting system in accordance with an embodiment of the invention. Roaming descriptor 651 (corresponding to roaming descriptor 507 as shown in FIG. 5) is contained in NIT 501. Roaming descriptor 651 maps platforms that have roaming agreements. For example, as shown with the service configuration in FIG. 2, platform A (platform_id=0x000001), platform B (platform_id=0x000002), and platform C (platform_id=0x000003) have a roaming agreement. As shown in FIG. 5, roaming descriptor 507 contains the platform identifiers of platforms A, B, and C. Roaming descriptor 651 provides this information by a variable number of platform_id members that are specified by descriptor_length 603. Descriptor_tag 601 identifies the descriptor as a roaming descriptor.

FIG. 6B shows roaming descriptor 653 used in a digital broadcasting system in accordance with an embodiment of the invention. With embodiments of the invention, roaming descriptor 653 may be used rather than roaming descriptor 651. Roaming descriptor 653 can provide information about a plurality of roaming agreements, where each roaming agreement corresponds to a corresponding group of platforms. (In such a case, each group of platforms needs a corresponding roaming descriptor 651.) Roaming_platform_data_length 611 indicates the number of platforms for a platform group, where each platform is identified by platform_id 613. Descriptor_tag 607 and descriptor 609 correspond to descriptor_tag 601 and descriptor_length 603 as previously discussed. However, descriptor_tag 601 and descriptor_tag descriptor_tag 607 typically have different values in order to distinguish between the different types of roaming descriptors.

FIG. 7 illustrates a functional block diagram of mobile terminal 700 in accordance with an embodiment of the invention. Mobile terminal 700 may include digital broadcast receiver 702, which may include antenna 701. Radio signals transmitted by a digital broadband broadcast network are received via antenna 701 and passed to receiver 702. Receiver 702 may decode consumable digital content from the received signals. Receiver 702 may also include, in various embodiments, a processor (e.g., a microcontroller) and/or memory. Digital content may additionally or alternatively be decoded by processor 704. Processor 704 may also enable digital content to be consumed in the form of video for output via one or more displays 708 or audio for output via speaker and/or earphones 710. Digital content may also be stored in memory 706 for future processing or consumption.

Memory 706 may also store program specific information and/or service information (PSI/SI), including information about digital content available in the future or stored from the past. A user of mobile terminal 700 may view this stored service information on display 708 and select an item of digital content for viewing, listening, or other uses via input 712, which may take the form of a keyboard, keypad, scroll wheel, or other input device(s) or combinations thereof. When digital content is selected, processor 704 may pass information to receiver 702, so that the receiver may act appropriately (e.g., tune a radio or filter signals based on PSI/SI in order to yield specific digital content for the user). Digital content and PSI/SI may be passed among functions within mobile terminal 700 using bus 714.

Various methods, operations, and the like described herein may, in various embodiments, be implemented in hardware and/or in software. Hardware may include one or more integrated circuits. For example, in various embodiments, the methods described may be performed by specialized hardware, and/or otherwise may not be implemented in general purpose processors. One or more chips and/or chipsets may be employed, including one or more application-specific integrated circuits (ASIC's).

Mobile terminal 700 may include other functional components (not shown) such as a cellular radio or other RF transceiver. Such functionality may be used for audio transmissions when coupled with a microphone (not shown) and speaker 710, as in a wireless phone, for example. Additional communication components (not shown) may be used to request and/or retrieve authorization to view or listen to protected digital content, enabling the enforcement of digital copyrights and pay-for-use regimes. Mobile terminal 700 may also include functionality to detect a location of the terminal, for example a Global Positioning System (GPS) or an Assisted GPS (AGPS). Although one particular functional diagram for mobile terminal 700 is provided, those skilled in the art understand that functionality may be added or removed, but the invention may still be implemented within the mobile terminal.

Mobile terminal 700 may encompass a variety of electronic devices including cellular phones, mobile video broadcast (DVB) receivers, pagers, personal digital assistants, laptop computers, automobile computers, portable video players, and other devices that may move among a plurality of cells and that include equipment for receiving signals from a wireless network. In addition to DVB receivers, mobile terminal 700 may encompass mobile receivers of other digital broadband broadcast systems, such as those previously mentioned.

While aspects of the invention have been described with respect to specific examples, including presently preferred modes of carrying out the invention, those skilled in the art will appreciate that there are numerous variations and permutations of the above described systems and techniques that fall within the spirit and scope of the invention as set forth in the appended claims.

We claim:

1. A method comprising:
(a) receiving, by a mobile terminal, digital content for a selected service from a current platform, the digital content being conveyed by a current signal, the current signal being broadcast within a current cell;
(b) obtaining platform information for another platform that provides the selected service in a candidate cell;
(c) determining whether a signal quality of the current signal is below a predetermined threshold;
(d) selecting another signal being transmitted within the candidate cell, the other signal being above the predetermined threshold, the other signal conveying the digital content of the selected service; and
(e) when the current platform is not available in the candidate cell, roaming to the other platform in the candidate cell in accordance with the platform information.

2. The method of claim 1, further comprising:
(f) when the current platform is available in the candidate cell, performing a handover to the current platform in the candidate cell.

3. The method of claim 1, (c) comprising:
(c)(i) measuring a signal strength of the current signal; and
(c)(ii) comparing the signal strength to the predetermined threshold.

4. The method of claim 1, (c) comprising:
(c)(i) measuring an error transmission rate of the current signal: and
(c)(ii) comparing the error transmission rate to the predetermined threshold.

5. The method of claim 1, the digital content comprising video information.

6. The method of claim 5, the mobile terminal supporting digital video broadcasting for handhelds (DVB-H).

7. The method of claim 6, the platform information being contained in at least one IP/MAC Notification Table (INT).

8. The method of claim 1, further comprising:
(f) acquiring roaming information; and
(g) performing (e) in accordance with the roaming information.

9. The method of claim 8, the roaming information being contained in a Network Information Table (NIT).

10. The method of claim 9, the roaming information being contained in a roaming descriptor of the NIT.

11. The method of claim 1, (d) comprising:
(d)(i) evaluating an availability of roaming services within the current cell and the candidate cell.

12. The method of claim 1, further comprising:
(f) discovering the roaming services available within the current cell and the candidate cell.

13. The method of claim 1, further comprising:
(f) determining the candidate cell from a plurality of candidate cells.

14. A method comprising:
(a) broadcasting, by a digital broadband broadcast network, roaming information in a transport stream to at least one mobile terminal; and
(b) broadcasting platform information in the transport stream to the at least one mobile terminal.

15. The method of claim 14, wherein:
the digital broadband broadcast network supports digital video broadcasting for handhelds (DVB-H); and
the platform information is contained in at least one IP/MAC Notification Table (INT).

16. The method of claim 15, wherein the roaming information is contained in a Network Information Table (NIT).

17. The method of claim 16, wherein the roaming information is contained in a roaming descriptor of the NIT.

18. A mobile terminal comprising:
a receiver for receiving at least one digital broadband broadcast signal; and
a processor, configured to perform:
(a) receiving, by a mobile terminal, digital content for a selected service from a current platform, the digital content being conveyed by a current signal, the current signal being broadcast within a current cell;
(b) obtaining platform information for another platform that provides the selected service in a candidate cell;
(c) determining whether a signal quality of the current signal is below a predetermined threshold;
(d) selecting another signal being transmitted within the candidate cell, the other signal being above the predetermined threshold, the other signal conveying the digital content of the selected service; and
(e) when the current platform is not available in the candidate cell, roaming to the other platform in the candidate cell in accordance with the platform information.

19. The mobile terminal of claim 18, the processor being further configured to:
(f) when the current platform is available in the candidate cell, performing a handover to the current platform in the candidate cell.

20. The mobile terminal of claim 18, the processor being further configured to:
(f) acquiring roaming information; and
(g) performing (e) in accordance with the roaming information.

21. The mobile terminal of claim 18, the processor being further configured to:
(f) evaluating an availability of roaming services within the current cell and the candidate cell when selecting the other signal being transmitted within the candidate cell.

22. A computer-readable medium having computer-executable instructions comprising:
(a) receiving, by a mobile terminal, digital content for a selected service from a current platform, the digital content being conveyed in a current signal, the current signal being broadcast within a current cell;
(b) obtaining platform information for another platform that provides the selected service in a candidate cell;
(c) determining whether a signal quality of the current signal is below a predetermined threshold;
(d) selecting another signal being transmitted within the candidate cell, the other signal being above the predetermined threshold, the other signal conveying the digital content of the selected service; and
(e) when the current platform is not available in the candidate cell, roaming to the other platform in the candidate cell in accordance with the platform information.

23. The computer-readable medium of claim 22, further comprising:
(f) when the current platform is available in the candidate cell, performing a handover to the current platform in the candidate cell.

24. The computer-readable medium of claim 22, further comprising:
(f) acquiring roaming information; and
(g) performing (e) in accordance with the roaming information.

25. The computer-readable medium of claim 22, further comprising:
(f) discovering the roaming services available within the current cell and the candidate cell; and
(g) evaluating an availability of the roaming services within the current cell and the candidate cell.

26. An apparatus comprising:
(a) means for receiving, by a mobile terminal, digital content for a selected service from a current platform, the digital content being conveyed by a current signal, the current signal being broadcast within a current cell;
(b) means for obtaining platform information for another platform that provides the selected service in a candidate cell;
(c) means for determining whether a signal quality of the current signal is below a predetermined threshold;
(d) means for selecting another signal being transmitted within the candidate cell, the other signal being above the predetermined threshold, the other signal conveying the digital content of the selected service; and
(e) means for roaming to the other platform in the candidate cell in accordance with the platform information when the current platform is not available in the candidate cell.

27. The apparatus of claim 26, further comprising:
(f) means for performing a handover to the current platform in the candidate cell when the current platform is available in the candidate cell.
